(19) United States
(12) Patent Application Publication
(10) Pub. No.: US 2020/0315198 A1
(43) Pub. Date: Oct. 8, 2020

(54) ACID MILK-CONTAINING HIGHLY CLEAR BEVERAGE, PACKAGED BEVERAGE, AND METHOD FOR HIGHLY CLARIFYING ACID MILK-CONTAINING BEVERAGE

(71) Applicants: ASAHI SOFT DRINKS CO., LTD., Sumida-ku, Tokyo (JP); ASAHI GROUP HOLDINGS, LTD., Sumida-ku, Tokyo (JP)

(72) Inventor: Akihiro Abe, Moriya-shi (JP)

(21) Appl. No.: 16/303,577

(22) PCT Filed: May 25, 2017
(86) PCT No.: PCT/JP2017/019485

§ 371 Date: Nov. 20, 2018

(30) Foreign Application Priority Data
Jun. 3, 2016 (JP) 2016-111649

(51) Int. Cl. A23C 9/13; A23L 2/70; A23L 2/68; A23L 2/60

(52) U.S. Cl. CPC A23C 9/1307; A23L 2/60; A23L 2/68; A23L 2/70

(57) ABSTRACT

There is provided an acid milk-containing highly clear beverage including acid milk and soybean polysaccharides, in which a content of non-fat milk solids is 0.009 mass % or less with respect to a total amount of the acid milk-containing highly clear beverage, a content of the soybean polysaccharides is 0.5 mass % or less with respect to the total amount of the acid milk-containing highly clear beverage, a pH of the acid milk-containing highly clear beverage is equal to or more than 2.8 and less than 3.5, and absorbency of the acid milk-containing highly clear beverage in a wavelength of 650 nm is 0.02 or less.

### TECHNICAL FIELD

The present invention relates to an acid milk-containing highly clear beverage, a packaged beverage, and a method for highly clarifying an acid milk-containing beverage.

### BACKGROUND ART

An acid milk beverage is known as a kind of refreshing beverage having turbidity, a unique flavor, and high palatability. The acid milk beverage contains a milk protein derived from acid milk as an insoluble substance. The milk protein in conventional acid milk beverages is generally dispersed in the beverage in a state of colloidal particles in which a plurality of molecules is gathered. In other words, in the conventional acid milk beverages, the colloidal particles containing milk proteins exist in a state of being dispersed as insoluble substances.

In addition, in the conventional acid milk beverages, in order to stabilize the dispersion state of the colloidal particles and suppress the colloidal particles from being aggregated and precipitated, a thickener such as pectin and soybean polysaccharides is generally mixed (Patent Document 1 and the like).

### RELATED DOCUMENT

### Patent Document

[Patent Document 1] Japanese Unexamined Patent Publication No. 2016-41018

### SUMMARY OF THE INVENTION

Demands for various refreshing beverages containing an acid milk beverage generally tend to increase during a period when the temperature is high, such as summer when a consumer consumes the beverage to quench thirst. However, the conventional acid milk beverages have turbidity as described in the section of the background art, due to the effect of the milk protein contained as an insoluble substance. For this reason, demands for the conventional acid milk beverages as thirst-quenching beverages tended to be lower than that for clear beverages having high transparency such as carbonated beverage, sport beverage, and water-like beverage imparted with fruit flavor.

In consideration of the circumstance, the present inventors intensively examined the design guideline for realizing a refreshing beverage that can exhibit a flavor unique to acid milk such as acid milk beverage and is also highly clear.

However, the conventional acid milk beverage disclosed in Patent Document 1 and the like had a limitation, from a viewpoint of improving the transparency as long as colloidal particles containing milk proteins were included in the beverage as insoluble substances.

The present invention provides a technology for highly clarifying a beverage which is assumed to contain acid milk.

The present inventors have found that not achieving high clarification of the conventional acid milk beverage by improving a dispersion state of colloidal particles containing milk proteins contained in the beverage as insoluble substances but causing the milk proteins to be contained in the beverage as soluble substances is effective as a design guideline for realizing highly clarified beverage which is assumed to contain the acid milk, thereby completing the present invention.

According to the present invention, there is provided an acid milk-containing highly clear beverage including:

acid milk, and

soybean polysaccharides,

in which a content of non-fat milk solids is 0.009 mass % or less with respect to a total amount of the acid milk-containing highly clear beverage,

in which a content of the soybean polysaccharides is 0.5 mass % or less with respect to a total amount of the acid milk-containing highly clear beverage,

in which a pH of the acid milk-containing highly clear beverage is equal to or more than 2.8 and less than 3.5, and

in which absorbency of the acid milk-containing highly clear beverage in a wavelength of 650 nm is 0.02 or less.

In addition, according to the present invention, there is provided a method for highly clarifying an acid milk-containing beverage including acid milk and soybean polysaccharides,

in which absorbency of the acid milk-containing highly clear beverage in a wavelength of 650 nm is 0.02 or less,

the method including a step of performing adjustment such that a content of non-fat milk solids is 0.009 mass % or less with respect to a total amount of the acid milk-containing highly clear beverage, a content of the soybean polysaccharides is 0.5 mass % or less with respect to the total amount of the acid milk-containing highly clear beverage, and a pH of the acid milk-containing highly clear beverage is equal to or more than 2.8 and less than 3.5.

According to the present invention, it is possible to provide a technology of highly clarifying a beverage which is assumed to contain acid milk.

### DESCRIPTION OF EMBODIMENTS

<Acid Milk-Containing Highly Clear Beverage>

An acid milk-containing highly clear beverage according to the present embodiment (hereinafter, referred to as present highly clear beverage) includes acid milk and soybean polysaccharides. In the present highly clear beverage, a content of non-fat milk solids is 0.009 mass % or less with respect to a total amount of the beverage, and a content of soybean polysaccharides is 0.5 mass % or less with respect to a total amount of the beverage. In addition, a pH of the present highly clear beverage is equal to or more than 2.8 to less than 3.5. Moreover, the present highly clear beverage is characterized in that absorbency of the beverage in a wavelength of 650 nm is 0.02 or less.

The conventional acid milk beverage generally has turbidity as described in the section of the background art. The reason that the conventional acid milk beverage has turbidity is considered that colloidal particles containing milk proteins contained as insoluble substances in the beverage are enlarged by being bonded with a component mixed as a dispersion stabilizing agent of the colloidal particles in the beverage, dispersed in a more stabilized state, and thereby visualized.

As described above, the present highly clear beverage is assumed that absorbency of the beverage in a wavelength of 650 nm is a value of 0.02 or less. The value of absorbency in relation to the present highly clear beverage is an extremely low value compared to the value to be described below in relation to the conventional acid milk beverage having turbidity. In this regard, in terms of transparency of the beverage, the present highly clear beverage is different from the conventional acid milk beverage which has only one thing in common with the present highly clear beverage, in a point that the beverage is a beverage which is assumed to contain acid milk.

The absorbency of the present highly clear beverage in a wavelength of 650 nm is 0.02 or less. From a viewpoint of improving excellency in transparency of the beverage, the absorbency of the present highly clear beverage is preferably 0.009 or less, more preferably 0.006 or less, and further more preferably 0.003 or less.

Here, absorbency of the conventional acid milk beverage in a turbid state in a wavelength of 650 nm is generally a value of 1 or greater in most cases. In addition, absorbency of the conventional sport beverage, which is different from the acid milk beverage but known as a kind of thirst-quenching beverages, in a wavelength of 650 nm is generally a value of around 0.2 in most cases. In this regard, the present highly clear beverage is considered to have an extraordinarily high transparency compared to the conventional acid milk beverage, sport beverage, and the like.

In addition, as described above, the present highly clear beverage is a beverage obtained by employing a specific composition that a pH of the beverage is controlled to be equal to or more than 2.8 and less than 3.5, and a content of non-fat milk solids with respect to a total amount of the beverage and a content of soybean polysaccharides with respect to the total amount of the beverage is in optimized balance. By employing the composition, milk proteins derived from acid milk can be contained in the present highly clear beverage as soluble substances. In addition, according to the specific composition in relation to the present highly clear beverage, it is possible to effectively inhibit the milk proteins contained in the beverage as soluble substances from being insoluble. That is, according to the present highly clear beverage, it is possible to prevent turbidization of a beverage and inhibit occurrence of an insoluble substance (floating substance).

Hereinafter, a specific composition of the present highly clear beverage will be described. In the present embodiment, a pH, a Brix value, acidity of citric acid, and absorbency of the present highly clear beverage are all indicated at a liquid temperature of 20° C.

The present highly clear beverage contains acid milk as an essential component.

The acid milk in the present embodiment represents milk of which the pH is less than 7, that is, milk in which a pH shows the acidity. Specifically, as long as the pH can be controlled to be less than 3.5, the acid milk according to the present embodiment may be fermented milk prepared by fermenting raw milk material using microorganisms such as lactic acid bacteria and bifidobacteria, or may be non-fermented milk prepared by not fermenting raw milk material using acid components such as fruit juice and acidulants. As the raw milk material used for preparing acid milk, any known materials can be used as long as the materials contain milk proteins. Examples of the raw milk material include raw milk, cow milk, whole milk powder, skim milk powder, whipped cream, concentrated milk, partially skim milk, condensed milk, milk powder, and the like. These may be used alone, or two or more thereof may be used in combination.

In addition, if the acid milk according to the present embodiment is within the range not impairing an object of the present invention from a viewpoint of highly clarifying a beverage, the acid milk may contain food additives such as various nutrient components, extracts, sweeteners, color additives, diluents, anti-oxidants, and the like. For this reason, as the acid milk according to the present embodiment, the conventional acid milk beverage containing milk proteins as insoluble substances may be used. That is, the present highly clear beverage may contain commercially available sterilized lactic acid bacteria beverages and commercially available sterilized acid milk beverages.

In addition, a content of non-fat milk solids with respect to a total amount of the present highly clear beverage is 0.009 mass % or more. From a viewpoint of inhibiting milk proteins contained in the non-fat milk solids from being insoluble in the beverage, the content of non-fat milk solids with respect to the total amount of the present highly clear beverage is preferably 0.006 mass % or less, and more preferably 0.003 mass % or less. In addition, a lower limit value of the content of non-fat milk solids with respect to the total amount of the present highly clear beverage is not particularly limited, but from a viewpoint of being able to exhibit a flavor unique to acid milk regarding the present highly clear beverage, the lower limit value of the content of non-fat milk solids with respect to the total amount of the present highly clear beverage may be 0.0001 mass % or more, or may be 0.0003 mass % or more, for example.

The non-fat milk solid is obtained by removing moisture and fat content from milk, and it means that the non-fat milk solid contains milk protein, carbohydrate (saccharide), ash containing mineral, and vitamin. In general, non-fat milk solids contained in 100 g of cow milk are around 8.3 g, and among these, milk proteins are around 3.0 g, saccharides are around 4.6 g, and ash is around 0.7 g.

In the present embodiment, the non-fat milk solids may be derived from acid milk, or may be derived from others than the acid milk.

The content of the non-fat milk solids can be measured by a quantification method of non-fat milk solids of fermented milk and lactic acid bacteria beverage stipulated in “Ministerial Ordinance in Relation to Component Standards and the Like of Milk and Dairy Product” in Food Sanitation Related Laws and Regulations (Ordinance of the Ministry of Health and Welfare, Number 52 of Dec. 27, 1951).

The present highly clear beverage contains soybean polysaccharides as an essential component. Since the present highly clear beverage contains a predetermined amount of soybean polysaccharides, it is possible to inhibit milk proteins dissolved in the beverage from being insoluble. In other words, in a case where a predetermined amount of the soybean polysaccharides is contained in the present highly clear beverage, it is possible to inhibit milk proteins dissolved in the beverage from being precipitated as insoluble substances and to prevent turbidization of the beverage. In this manner, the soybean polysaccharides in the present highly clear beverage function as a stabilizing agent for maintaining solubility of the milk proteins with respect to water.

In addition, as long as hemicellulose is contained as a main component, any known soybean polysaccharides can be used as the soybean polysaccharides according to the present embodiment.

In addition, a content of the soybean polysaccharides with respect to a total amount of the present highly clear beverage is 0.5 mass % or less from a viewpoint of realizing high clarification of a beverage, but from a viewpoint of inhibiting the milk proteins contained in the beverage from being insoluble, the content of the soybean polysaccharides with respect to a total amount of the present highly clear beverage is preferably 0.4 mass % or less, more preferably 0.3 mass % or less, and most preferably 0.2 mass % or less. In addition, a lower limit value of the content of the soybean polysaccharides with respect to a total amount of the present highly clear beverage is not particularly limited, but may be 0.05 mass % or more, or may be 0.1 mass % or more.

A pH of the present highly clear beverage is equal to or more than 2.8 and less than 3.5. With this, it is possible to maintain solubility of the milk proteins contained in the present highly clear beverage as soluble substances with respect to water. It is known that an isoelectric point of the milk proteins is generally a pH of 4.6. The value of the isoelectric point is resulted from an isoelectric point (pH 4.6) of casein known as a main component of the milk proteins.

In addition, an upper limit value of a pH of the present highly clear beverage is less than 3.5, but from a viewpoint of preventing the milk proteins contained in the beverage from being precipitated as insoluble substances, the upper limit value of the pH of the present highly clear beverage is preferably a pH of 3.4 or less, and more preferably a pH of 3.3 or less. On the other hand, from a viewpoint of inhibiting fragrance components in the beverage from deteriorating, a lower limit value of the pH of the present highly clear beverage is preferably a pH of 2.8 or more. For this reason, in a case where the pH of the present highly clear beverage is controlled to be the lower limit value or more, it is possible to improve palatability of the beverage.

In addition, in order to improve palatability of the beverage in terms of flavor, a sweetener may be contained in the present highly clear beverage. As the sweetener, a known sweetener can be used, and examples of the sweetener include saccharides such as sucrose, glucose, fructose, lactose, maltose, and fructose-glucose liquid sugar, low-sweetness sweetener such as xylitol and D-sorbitol, high-sweetness sweetener such as thaumatin, stevia extract, disodium glycyrrhizate, acesulfame potassium, sucralose, aspartame, saccharine, neotame, and saccharine sodium.

In addition, from a viewpoint of effectively preventing turbidization of the beverage, an acidulant may be contained in the present highly clear beverage. As the acidulant, a known acidulant can be used, and examples of the acidulant include tris odium citrate, citric anhydride, adipic acid, gluconic acid, succinic acid, tartaric acid, lactic acid, fumaric acid, malic acid, phosphoric acid, phytic acid, and ascorbic acid, or salts thereof.

In addition, if the present highly clear beverage is within the range not impairing an object of the present invention from a viewpoint of highly clarifying a beverage, the present highly clear beverage may contain a food additive such as fruit juice, various nutrient components, extracts, color additives, diluents, anti-oxidants, and the like.

In addition, from a viewpoint of improving palatability of the beverage, a Brix value of the present highly clear beverage is preferably equal to or more than 1° and equal to or less than 10°, more preferably equal to or more than 3° and equal to or less than 9°, and further more preferably equal to or more than 4° and equal to or less than 8°.

In addition, from a viewpoint of improving palatability of the beverage, acidity of the present highly clear beverage is preferably equal to or more than 0.05 mass % and equal to or less than 0.3 mass %, and more preferably equal to or more than 0.1 mass % and equal to or less than 0.2 mass %. “Acidity” of a beverage according to the present embodiment indicates a value obtained by converting an amount of acid contained in the beverage into an equivalent of a citric acid, that is, a numerical value represented as acidity of a citric acid (mass %).

A container filled with the present highly clear beverage can be appropriately selected and used as long as the container is a known hermetic container. Specific examples of the container include hermetic containers made of a simple substance such as glass, plastic (polyethylene terephthalate (PET) and the like), aluminum, and steel, a composite material, or a laminate material. In addition, the shape of the container is not particularly limited, but examples of the shape of the container include a can container and a bottle container. Moreover, the color of the container filled with the present highly clear beverage is not particularly limited, but is preferably colorless and transparent.

<Method for Highly Clarifying an Acid Milk-Containing Beverage>

High clarification of an acid milk-containing beverage according to the present embodiment is a technique of preventing milk proteins dissolved in the beverage which is assumed to contain acid milk and soybean polysaccharides from being insoluble and precipitated, which causes turbidization of the beverage and occurrence of insoluble substances (floating substances), thereby highly clarifying the beverage. Here, it is assumed that absorbency of the acid milk-containing beverage according to the present embodiment in a wavelength of 650 nm is 0.02 or less. Specifically, high clarification of the acid milk-containing beverage according to the present embodiment includes a step of performing adjustment such that a content of non-fat milk solids is 0.009 mass % or less with respect to a total amount of the acid milk-containing beverage, a content of the soybean polysaccharides is 0.5 mass % or less with respect to the total amount of the acid milk-containing beverage is 0.5 mass % or less, and a pH of the acid milk-containing beverage is equal to or more than 2.8 and less than 3.5.

Hereinabove, the embodiment of the present invention is described, but this is an example of the present invention and various compositions other than the above-described composition can be employed.

### EXAMPLES

Hereinafter, the present invention will be described using examples and comparative examples, but the present invention is not limited thereto.

<Preparation of Acid Milk-Containing Highly Clear Beverage According to Examples 1 to 7 and Comparative Example 1>

Fructose-glucose liquid sugar, sugar, and common salt which were dissolved in water in advance were added to and mixed with a commercially available sterilized lactic acid bacteria beverage in a turbid state such that the mixture ratio was as shown in the following Table 1. The commercially available sterilized lactic acid bacteria beverage was diluted in advance, depending on the necessity. Subsequently, while dissolving soybean polysaccharides in the obtained mixture solution such that the mixture ratio was as shown in the following Table 1, the pH of the solution was adjusted by adding a predetermined amount of acidulant containing a citric acid, a lactic acid, and a trisodium citrate to the solution and mixing thereof such that the pH of the solution was 3.3, thereby preparing an acid milk-containing highly clear beverage. A Brix value of the obtained acid milk-containing highly clear beverage was 8.0°, and acidity of the citric acid was 0.15 mass %.

Subsequently, the obtained acid milk-containing highly clear beverage was subjected to heating and sterilization treatment at 115° C. for 30 seconds. Subsequently, within 5 seconds after the heating and sterilization treatment, the obtained acid milk-containing highly clear beverage was subjected to cooling treatment for less than 10 seconds such that a liquid temperature thereof was 80° C., and then the beverage was filed in a transparent container and maintained for 2 minutes. After that, the acid milk-containing highly clear beverage was cooled with water such that the liquid temperature thereof was 20° C., thereby obtaining a packaged acid milk-containing highly clear beverage according to Examples 1 to 7 and Comparative Example 1.

<Preparation of Acid Milk-Containing Highly Clear Beverage According to Example 8>

A packaged acid milk-containing highly clear beverage according to Example 8 was prepared by the same method as that of Example 6 except that the pH was adjusted by using a predetermined amount of acidulant containing a citric acid, a lactic acid, and a trisodium citrate such that the pH of the solution in which soybean polysaccharides were dissolved was 2.8.

<Preparation of Acid Milk-Containing Highly Clear Beverage According to Comparative Example 2>

A packaged acid milk-containing highly clear beverage according to Comparative Example 2 was prepared by the same method as that of Examples 1 to 7 and Comparative Example 1 except that the pH was adjusted not by dissolving soybean polysaccharides therein, that is, not mixing soybean polysaccharides therewith.

<Preparation of Acid Milk-Containing Highly Clear Beverage According to Comparative Example 3>

A packaged acid milk-containing highly clear beverage according to Comparative Example 3 was prepared by the same method as that of Comparative Example 1 except that the pH was adjusted by using a predetermined amount of acidulant containing a citric acid, a lactic acid, and a trisodium citrate such that the pH of the solution in which soybean polysaccharides were dissolved was 2.8.

<Preparation of Acid Milk-Containing Beverage According to Reference Example 1>

A packaged acid milk-containing beverage according to Reference Example 1 was prepared by the same method as that of Examples 1 to 7 and Comparative Example 1 except that soybean polysaccharides were not mixed therein, the pH was adjusted by using a predetermined amount of acidulant containing a citric acid, a lactic acid, and a trisodium citrate such that the pH was 3.6, and adjustment was performed not by performing heating and sterilization treatment such that the liquid temperature of the beverage was 20° C.

<Preparation of Acid Milk-Containing Beverage According to Reference Example 2>

A packaged acid milk-containing beverage was prepared by the same method as that of Examples 1 to 7 and Comparative Example 1 except that soybean polysaccharides were not mixed therein, the pH was adjusted by using a predetermined amount of acidulant containing a citric acid, a lactic acid, and a trisodium citrate such that the pH was 3.9, and adjustment was performed not by performing heating and sterilization treatment such that the liquid temperature of the beverage was 20° C.

The following evaluation was performed on each of the obtained acid milk-containing highly clear beverages.
Presence or absence of insoluble substances (floating substances): Skilled panelists evaluated the appearance of each beverage by visual observation in accordance with the following evaluation criteria.

A: Insoluble substances (floating substances) were not contained.

B: Although it was a level at which no practical problem was caused as a highly clear beverage, a slight amount of insoluble substances (floating substances) were contained therein.

C: A certain level of amount of insoluble substances (floating substances) at which a practical problem could be caused as a highly clear beverage was contained.
Necessity of turbidity: Skilled panelists evaluated the appearance of each beverage by visual observation in accordance with the following evaluation criteria.

A: Turbidity was not found.

B: Although it was a level at which no practical problem was caused as a highly clear beverage, slight turbidity was found.

C: A certain level of turbidity at which a practical problem could be caused as a highly clear beverage was found.
Absorbency in a wavelength of 650 nm: Absorbency of each beverage in a wavelength of 650 nm was measured by using a spectrophotometer. The measurement of absorbency was performed under a condition of a temperature of 20° C. using a quartz cell. The notation of “n.d.” in the following table indicates a value below a measurement limit.

The evaluation result in relation to the above evaluation items is shown in the following Table 1.

TABLE 1

| | | | | | | | | | Com- | Com- | | Com- |
|---|---|---|---|---|---|---|---|---|---|---|---|---|
| | | Example | Example | Example | Example | Example | Example | Example | parative | parative | Example | parative |
| | | 1 | 2 | 3 | 4 | 5 | 6 | 7 | Example 1 | Example 2 | 8 | Example 3 |
| Content of | Non-fat milk | 0.0003 | 0.0015 | 0.0015 | 0.0015 | 0.003 | 0.003 | 0.006 | 0.01 | 0.01 | 0.003 | 0.01 |
| mixture | solids [mass %] | | | | | | | | | | | |
| component | Soybean | 0.5 | 0.1 | 0.2 | 0.5 | 0.2 | 0.5 | 0.5 | 0.5 | — | 0.5 | 0.5 |
| with | polysaccharides | | | | | | | | | | | |
| respect to | [mass %] | | | | | | | | | | | |
| total | Fructose-glucose | 3.2 | 3.2 | 3.2 | 3.2 | 3.2 | 3.2 | 3.2 | 3.2 | 3.2 | 3.2 | 3.2 |
| amount of | liquid sugar | | | | | | | | | | | |
| beverage | [mass %] | | | | | | | | | | | |
| | Sugar [mass %] | 5.6 | 5.6 | 5.6 | 5.6 | 5.6 | 5.6 | 5.6 | 5.6 | 5.6 | 5.6 | 5.6 |
| | Common Salt | 0.02 | 0.02 | 0.02 | 0.02 | 0.02 | 0.02 | 0.02 | 0.02 | 0.02 | 0.02 | 0.02 |
| | [mass %] | | | | | | | | | | | |

| | | | | | | | | | | | |
|---|---|---|---|---|---|---|---|---|---|---|---|
| pH of beverage | 3.3 | 3.3 | 3.3 | 3.3 | 3.3 | 3.3 | 3.3 | 3.3 | 3.3 | 2.8 | 2.8 |
| Absorbency of beverage | n.d. | n.d. | 0.0003 | 0.0004 | 0.0006 | 0.001 | 0.0024 | 0.0055 | 0.001 | 0.0004 | 0.0004 |
| in a wavelength | | | | | | | | | | | |
| of 650 nm | | | | | | | | | | | |
| Presence or absence | A | A | A | A | A | A | A | A | C | A | A |
| of insoluble | | | | | | | | | | | |
| substances | | | | | | | | | | | |
| (floating substances) | | | | | | | | | | | |
| Necessity of turbidity | A | A | A | A | A | A | B | C | A | A | C |

The acid milk-containing highly clear beverage of each example was excellent in transparency in a point of not having turbidity and was a highly clarified beverage having a small amount of impurities. On the other hand, the acid milk-containing highly clear beverage of Comparative Examples 1 and 3 was excellent in transparency in a point that absorbency in a wavelength of 650 nm was 0.02 or less, but was a beverage having turbidity at a level at which a practical problem could be caused as a highly clear beverage. In addition, the acid milk-containing highly clear beverage of Comparative Example 2 was excellent in transparency in a point that absorbency in a wavelength of 650 nm was 0.02 or less, but had room for improvement as a highly clear beverage in a point that impurities were deposited.

It was checked that the beverage of Reference Example 1, of which pH was adjusted to be 3.6, was not highly clarified and in a turbid state as it was. In addition, it was checked that the beverage of Reference Example 2, of which pH was adjusted to be 3.9 was not highly clarified and in a turbid state as it was. Moreover, regarding the beverage of Reference Example 2, it was checked that insolublization of milk proteins proceeded in the beverage.

Priority is claimed on Japanese Patent Application No. 2016-111649, filed on Jun. 3, 2016, the content of which is incorporated herein.

1. An acid milk-containing highly clear beverage comprising:
acid milk; and
soybean polysaccharides,
wherein a content of non-fat milk solids is 0.009 mass % or less with respect to a total amount of the acid milk-containing highly clear beverage,
wherein a content of the soybean polysaccharides is 0.5 mass % or less with respect to the total amount of the acid milk-containing highly clear beverage,
wherein a pH of the acid milk-containing highly clear beverage is equal to or more than 2.8 and less than 3.5, and
wherein absorbency of the acid milk-containing highly clear beverage in a wavelength of 650 nm is 0.02 or less.

2. The acid milk-containing highly clear beverage according to claim 1,
wherein the absorbency of the acid milk-containing highly clear beverage in a wavelength of 650 nm is 0.009 or less.

3. The acid milk-containing highly clear beverage according to claim 1, further comprising:
a sweetener.

4. The acid milk-containing highly clear beverage according to claim 1, further comprising:
an acidulant.

5. The acid milk-containing highly clear beverage according to claim 1,
wherein a Brix value of the acid milk-containing highly clear beverage is equal to or more than 1° and equal to or less than 10°.

6. A packaged beverage,
wherein the acid milk-containing highly clear beverage according to claim 1 is filled in a transparent container.

7. A method for highly clarifying an acid milk-containing beverage including acid milk and soybean polysaccharides,
wherein absorbency of the acid milk-containing beverage in a wavelength of 650 nm is 0.02 or less,
the method comprising:
a step of performing adjustment such that a content of non-fat milk solids is 0.009 mass % or less with respect to a total amount of the acid milk-containing beverage, a content of the soybean polysaccharides is 0.5 mass % or less with respect to the total amount of the acid milk-containing beverage, and a pH of the acid milk-containing beverage is equal to or more than 2.8 and less than 3.5.
